(19) United States
(12) Patent Application Publication
(10) Pub. No.: US 2010/0007351 A1
(43) Pub. Date: Jan. 14, 2010

(54) ASSEMBLED-BATTERY VOLTAGE MEASURING DEVICE AND ASSEMBLED-BATTERY VOLTAGE SYSTEM USING IT

(76) Inventors: Daisuke Kurose, Kawasaki-shi (JP); Tetsuro Itakura, Tokyo (JP); Yoshinao Tatebayashi, Yokohama-shi (JP); Nobuo Shibuya, Hiratsuka-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 12/407,849

(22) Filed: Mar. 20, 2009

(30) Foreign Application Priority Data
Jul. 14, 2008 (JP) 2008-183149

(51) Int. Cl. G01N 27/416

(52) U.S. Cl. 324/429

(57) ABSTRACT

A voltage measuring device includes a sample-and-hold circuit which alternates between (a) a sample mode in which a signal input from a cell to be measured is sampled so that a voltage across a first capacitor becomes equal to a voltage across the cell to be measured, and a voltage across a second capacitor having its one end connected to one end of the first capacitor becomes equal to zero volts and (b) a hold mode in which the connection between the first and second capacitors is opened, the first capacitor establishes a connection between an inverting input terminal and a non-inverting output terminal of an operational amplifier, and the second capacitor establishes a connection between a non-inverting input terminal and an inverting output terminal of the operational amplifier, and an analog-to-digital converter which converts a signal output from the operational amplifier into a digital signal.

### CROSS-REFERENCE TO RELATED APPLICATIONS

This application is based upon and claims the benefit of priority from prior Japanese Patent Application No. 2008-183149, filed Jul. 14, 2008, the entire contents of which are incorporated herein by reference.

### BACKGROUND OF THE INVENTION

1. Field of the Invention

The present invention relates to a device for measuring the voltage of an assembled battery having a plurality of series-connected cells and an assembled-battery system using it.

2. Description of the Related Art

In recent years, electric automobiles and hybrid automobiles have received attention from the point of view of environmental load. It is required that the on-board battery which governs the running performance of electric and hybrid automobiles should provide a high voltage of the order of some tens of volts in order to drive the motor. As the on-board battery use may be made of an assembled battery in which a number of (some tens of) cells each of the order of 1 to 2V are connected in series to obtain a high voltage.

The assembled battery has a problem that there are variations in voltage among its cells. Since the cells are connected in series, a common current will flow though each cell. However, variations in capacitance among the cells will produce variations in voltage among the cells. That is, the voltage may reach a upper-limiting voltage during charging (overcharged condition) or a lower-limiting voltage during discharging (over-discharged condition). Either of the overcharged condition and the over-discharged condition of the cells causes a degradation in the performance of the assembled battery. Therefore, the assembled-battery system is provided with a voltage measuring device for monitoring the voltages of the individual cells that constitute the assembled battery. The measurements by the voltage measuring device are employed to compensate for variations in voltage among the cells.

Many voltage measuring devices convert the voltage of each cell into a digital value (quantization) through the use of an analog-to-digital converter (ADC) and take in it. Since the cells are connected in series, the voltages to ground of the respective cells differ from one another. In order to input the voltage of each cell to the ADC, it is required to shift the to-ground voltages of the respective cells to a common value at the time of measurement.

Conventionally, it is known a voltage detecting circuit which is referred to as a flying capacitor circuit. The operation of this flying capacitor circuit is briefly explained here as follows:

A cell to be measured is selected by turning on corresponding switches (hereinafter referred to as cell select switches). The terminals of each cell can be connected to the terminals of a capacitor (hereinafter referred to as a sampling capacitor) through a corresponding cell select switch. The sampling capacitor is charged by a cell to be measured. The terminals of the sampling capacitor can be connected to the reference voltage terminal and the input terminal of the ADC through switches (hereinafter referred to as measuring switches). The measuring switches are turned off during charging. The voltage across the sampling capacitor becomes equal to the voltage across the cell to be measured through charging.

After the sampling capacitor has been charged, the cell select switches corresponding to the cell to be measured is turned off and the measuring switch is turned on. The terminal on the high-voltage side (positive terminal) of the sampling capacitor is connected to the input terminal of the ADC and its terminal on the low-voltage side (negative terminal) is grounded (or reset to another reference potential) and connected to the reference voltage terminal of the ADC. The voltage across the sampling capacitor is virtually held provided that the effect of parasitic capacitance to be described later is not taken into consideration. It therefore becomes possible to uniformly shift the to-ground voltage on the low-voltage side of the sampling capacitor to the reference voltage.

With the voltage measurement by the flying capacitor circuit, however, there arise measurement errors due to parasitic capacitances associated with the switches. The flying capacitor circuit described above is equipped with cell select switches each of which corresponds to a respective one of the cells and a measuring switch corresponding to the sampling capacitor. The measurement errors due to parasitic capacitances associated with these switches are quantitatively evaluated on the assumption of the following conditions:
All the switches have the same parasitic capacitance Cp.
All the cells have the same voltage VB.
The cells connected in series are n in number and the n-th cell (i.e., the cell the to-ground voltage of which is the highest) is set as a candidate for measurement.

While the sampling capacitor is being charged, the parasitic capacitors are also charged. The nodes on the high- and low-voltage sides of the sampling capacitor are taken here to be X and Y, respectively. When the measuring switch is turned on, the node X is connected to the input terminal of the ADC and the node Y is grounded and connected to the reference voltage terminal of the ADC. Thus, the voltage at the node Y is forced to coincide with ground voltage. At the node X, on the other hand, redistribution of charges occurs between the sampling capacitor and the parasitic capacitors. Specifically, charges are redistributed so that the voltage across the parasitic capacitor associated with the cell select switch connected to the node X, the voltage across the parasitic capacitor associated with the measuring select switch connected to the node X and the voltage across the sampling capacitor coincide with one another. That is, the voltage V_{X-Y} across the sampling capacitor is represented by:

$$\begin{matrix}{V}_{X - Y} = \frac{{C}_{S} {V}_{B} + {nV}_{B} Σ {C}_{P}}{{C}_{S} + Σ {C}_{P}} \\ = {V}_{B} + \frac{( n - 1 ) Σ {C}_{P}}{{C}_{S} + Σ {C}_{P}} {V}_{B}\end{matrix} \qquad ( 1 )$$

where ΣCp is the sum of the capacitances Cp of parasitic capacitors associated with all the switches connected to the node X. According to expression (1), the measurement error increases as Cp and n increase. The measurement error for each cell is not constant. The measurement error varies depending upon where in the assembled battery the cell to be measured is located.

The cell voltage detecting circuit disclosed in JP-A 2001-201522 (KOKAI) suppresses measurement errors due to parasitic capacitances associated with the switches in the above flying capacitor circuit. Specifically, a switch is further set between the sampling capacitor and the cell select switch (hereinafter referred to as a separating switch). The separating switch is turned on when the sampling capacitor is charged and turned off during voltage measurement. Therefore, the parasitic capacitance associated with the cell select switch can be excluded from candidates for redistribution of charges. Naturally, the separating switch is accompanied by a parasitic capacitance (Cp), which will become a candidate for redistribution of charges. However, the parasitic capacitance associated with the separating switch has less effect on measurement errors than that associated with the cell select switch. Specifically, the voltage V_{X-Y} across the sampling capacitor is represented by:

$$\begin{matrix}{V}_{X - Y} = \frac{{C}_{S} {V}_{B} + {nV}_{B} 2 {C}_{P}}{{C}_{S} + 2 {C}_{P}} \\ = {V}_{B} + \frac{( n - 1 ) 2 {C}_{P}}{{C}_{S} + 2 {C}_{P}} {V}_{B}\end{matrix} \qquad ( 2 )$$

The conventional flying capacitor circuit and the voltage detecting circuit disclosed in JP-A 2001-201522 (KOKAI) have a problem of measurement errors due to parasitic capacitances associated with switches.

### BRIEF SUMMARY OF THE INVENTION

According to an aspect of the invention, there is provided a voltage measuring device for use with an assembled battery including a plurality of series-connected cells, comprising: a sample-and-hold circuit including a first capacitor, a second capacitor and an operational amplifier, a sample-and-hold circuit being alternated between (a) a sample mode in which a signal input from a cell to be measured of the plurality of cells is sampled so that a voltage across the first capacitor becomes equal to a voltage across the cell to be measured, and a voltage across the second capacitor having its one end connected to one end of the first capacitor becomes equal to zero volts and (b) a hold mode in which the connection between the first capacitor and second capacitor is opened, the first capacitor establishes a connection between an inverting input terminal and a non-inverting output terminal of the operational amplifier, and the second capacitor establishes a connection between a non-inverting input terminal and an inverting output terminal of the operational amplifier; and an analog-to-digital converter which converts a signal output from the operational amplifier into a digital signal.

According to another aspect of the invention, there is provided a voltage measuring device for use in an assembled battery including a plurality of series-connected cells, comprising: a sample-and-hold circuit including a first capacitor, a second capacitor and an operational amplifier, a sample-and-hold circuit being alternated between (a) a sample mode in which a signal input from a pair of first and second adjacent cells, as a candidate for measurement, of the plurality of cells is sampled so that a voltage across the first capacitor becomes equal to a voltage across the first cell, and a voltage across the second capacitor having its one end connected to one end of the first capacitor becomes equal to a voltage across the second cell and (b) a hold mode in which the connection between the first capacitor and second capacitor is opened, the first capacitor establishes a connection between an inverting input terminal and a non-inverting output terminal the an operational amplifier, and the second capacitor establishes a connection between a non-inverting input terminal and an inverting output terminal of the operational amplifier; and an analog-to-digital converter which converts a signal output from the operational amplifier into a digital signal.

According to another aspect of the invention, there is provided a voltage measuring device for use in an assembled battery including a plurality of series-connected cells, comprising: a sample-and-hold circuit including a first capacitor, a second capacitor and an operational amplifier, a sample-and-hold circuit being adapted to be switched between first operation mode and second operation mode, the first operation modes alternating between (a) a first sample mode in which a signal input from a pair of first and second adjacent cells, as a candidate for measurement, of the plurality of cells is sampled so that a voltage across the first capacitor becomes equal to a voltage across the first cell, and a voltage across the second capacitor having its one end connected to one end of the first capacitor becomes equal to a voltage across the second cell and (b) a first hold mode in which the connection between the first capacitor and second capacitor is opened, the first capacitor establishes a connection between an inverting input terminal and a non-inverting output terminal of the operational amplifier, and the second capacitor establishes a connection between a non-inverting input terminal and an inverting output terminal of the operational amplifier and the second operation mode alternating between (c) a second sample mode in which a signal input from a cell to be measured of the plurality of cells is sampled so that the voltage across the first capacitor becomes equal to a voltage across the cell to be measured, and the voltage across the second capacitor becomes equal to zero volts and (d) a second hold mode in which the connection between the first capacitor and second capacitor is opened, the first capacitor establishes the connection between the inverting input terminal and the non-inverting output terminal of the operational amplifier, and the second capacitor establishes the connection between the non-inverting input terminal and the inverting output terminal of the operational amplifier; and an analog-to-digital converter which converts a signal output from the operational amplifier into a digital signal.

### BRIEF DESCRIPTION OF THE SEVERAL VIEWS OF THE DRAWING

FIG. 1 is a schematic and block diagram representation of an assembled-battery voltage measuring device according to a first embodiment;

FIG. 2 is a diagram illustrating an application of the voltage measuring device of FIG. 1 to an assembled-battery system;

FIG. 3A is a diagram illustrating the connected conditions in the first phase of the voltage measuring device of FIG. 1;

FIG. 3B is a diagram illustrating the connected conditions in the second phase of the voltage measuring device of FIG. 1;

FIG. 4 is a timing diagram illustrating on-off control of switches by the voltage measuring device of FIG. 1;

FIG. 5A is a conceptual diagram of voltages at the nodes A and Y in FIG. 3A;

FIG. 5B is a conceptual diagram of voltages at the nodes A and Y in FIG. 3B;

FIG. 6 is a diagram for use in explanation of problems which arise when the voltage measuring device of FIG. 1 is operated continuously;

FIG. 7 is a schematic and block diagram representation of an assembled-battery voltage measuring device according to a second embodiment;

FIG. 8 conceptually illustrates the operation of an assembled-battery voltage measuring device according to a third embodiment; and

FIG. 9 is a flowchart illustrating the operation of the assembled-battery voltage measuring device of the third embodiment.

### DETAILED DESCRIPTION OF THE INVENTION

The embodiments of the present invention will be described hereinafter with reference to the accompanying drawings.

### First Embodiment

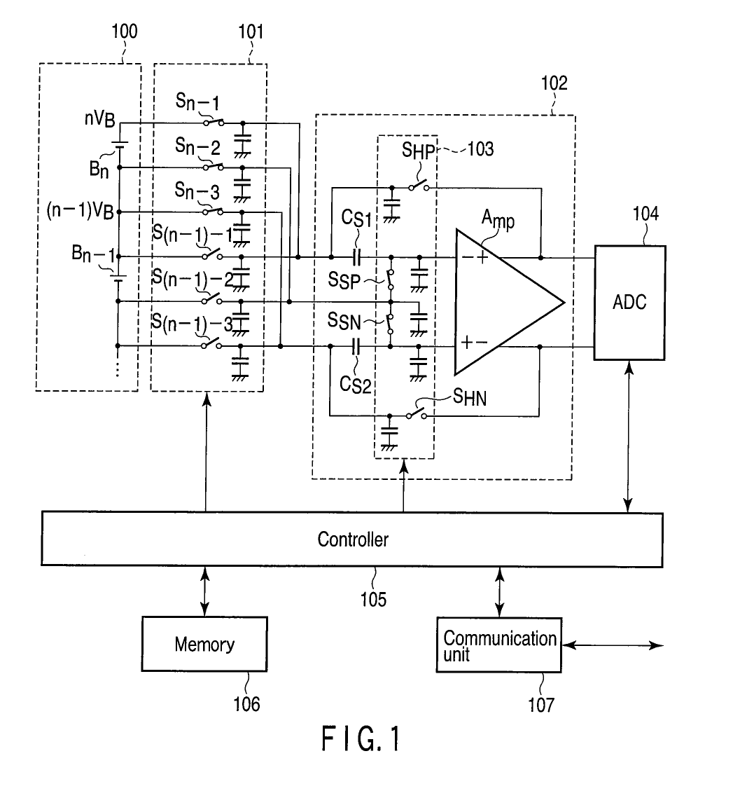

As shown in FIG. 1, a voltage measuring device adapted for use with an assembled battery 100 according to a first embodiment of the present invention is equipped with a first switch group 101, a sample-and-hold circuit 102, an analog-to-digital converter (ADC) 104, a controller 105, a memory 106, and a communication unit 107.

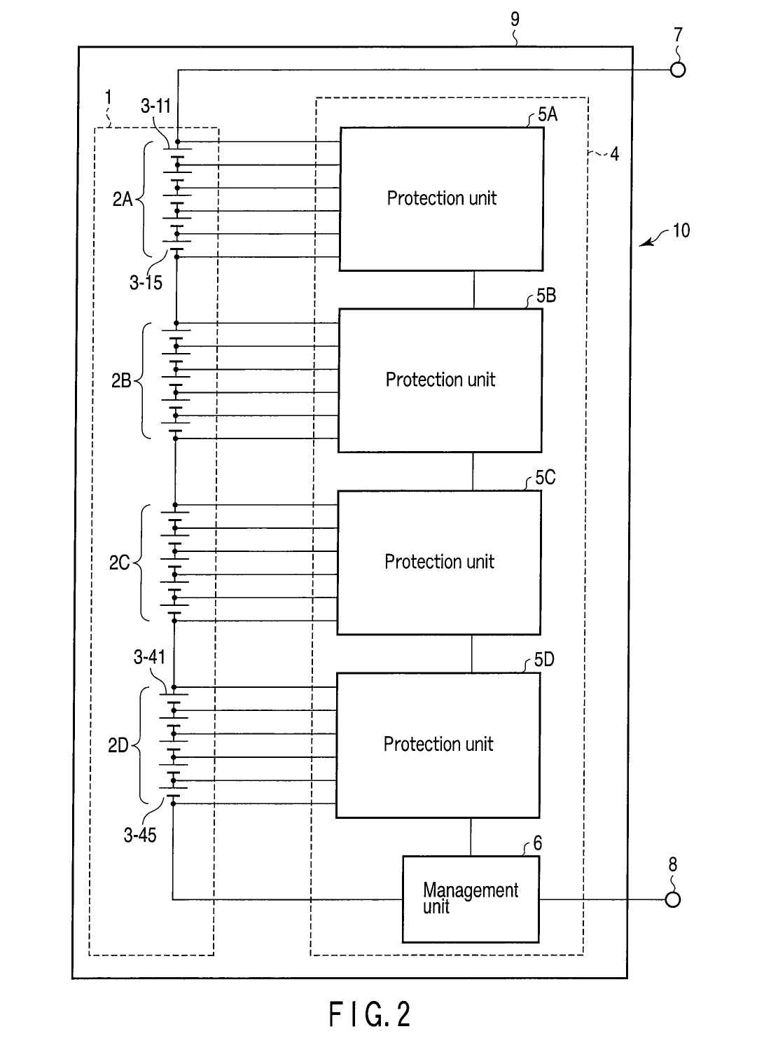

First, reference is made to FIG. 2 to describe an application of the voltage measuring device of FIG. 1 to an assembled battery system.

As shown in FIG. 2, an assembled battery 1 is composed of a plurality of series-connected battery modules 2A, 2B, 2C and 2D each of which has a plurality of series-connected cells 3-nm (in the example of FIG. 2, n=1, 2, 3, 4 and m=1, 2, 3, 4, 5). An assembled battery 100 in FIG. 1 corresponds to an individual one of the battery modules 2A, 2B, 2C, and 2D in FIG. 2. The cells 3-nm are each a secondary battery, such as a lithium ion battery (LIB). The terminals of the assembled battery 1 are connected to external terminals 7 and 8 for connection to external equipment, such as a motor. One of the terminals of the assembled battery 1 is connected through a management unit 6 to the external terminal 8.

A protection device 4 may be housed in a package different from the one for the assembled battery 1, but may be housed in a package 9 common to the assembled battery 1 as shown in FIG. 2, in which case the protection device and the assembled battery form an assembled battery system (battery pack). The protection device 4 has voltage measurement, overcharge protection and over-discharge protection functions for the individual cells 3-nm that constitute the assembled battery 1. The protection device has protection units 5A, 5B, 5C and 5D which correspond to the battery modules 2A, 2B, 2C and 2D, respectively, and the management unit 6 common to the battery modules. The voltage detecting device of FIG. 1 is incorporated into each of the protection units 5A, 5B, 5C and 5D.

Each of the protection units 5A, 5B, 5C and 5D performs a charge or discharge inhibiting operation when the voltages of the individual cells 3-nm in the corresponding battery module reach a charge or discharge inhibiting voltage.

The assembled battery 100 has n number of cells B1 to Bn (n is a natural number) which are connected in series with one another. The voltage of each cell is supposed to be VB. Therefore, assuming that the voltage on the low-voltage side of the first-stage cell B1 is 0, the voltages on the high- and low-voltage sides of the n-th-stage cell Bn will be nVB and (n-1)VB, respectively.

The cells B1 to Bn are connected at their positive terminals (high-voltage side terminals) to switches S1-1 to Sn-1, respectively, and at their negative terminals (low-voltage side terminals) to paired switches S1-2 and S1-3 to Sn-2 and Sn-3, respectively. In FIG. 1, parasitic capacitances associated with the switches S1-1 to Sn-1, S1-2 to Sn-2 and S1-3 to Sn-3 are illustrated conceptually. These switches are, for example, MOS switches and are on-off controlled as the first switch group 101 by the controller 105.

Specifically, the switches Si-1, Si-2 and Si-3 corresponding to a cell Bi (i is a natural number equal to or smaller than n) selected as a subject for measurement by the controller are turned on and the other switches are turned off. The cell Bi alone is connected to the sample-and-hold circuit 102 and the differential voltage is sampled (the first phase of the voltage measuring device of FIG. 1). Subsequently, all the switches including the switches Si-1, Si-2 and Si-3 are turned off and the ADC circuit 104 measures the differential voltage of the cell Bi output from the sample-and-hold circuit 102 (the second phase of the voltage measuring device of FIG. 1). After that, the controller 105 selects each cell as a candidate for measurement in sequence and repeats the above operation.

The sample-and-hold circuit 102 has an operational amplifier Amp, capacitors (hereinafter referred to as sampling capacitors) CS1 and CS2, switches (hereinafter referred to as sampling switches) SSP and SSN, and switches (hereinafter referred to as hold switches) SHP and SHN. The sampling switches SSP and SSN and the hold switches SHP and SHN are MOS switches by way of example and on-off controlled as a second switch group 103 by the controller 105. In FIG. 1, parasitic capacitances associated with the sampling switches SSP and SSN and the hold switches SHP and SHN are illustrated conceptually.

The sample-and-hold circuit 102 alternates between two operation modes—the so called sample and hold modes. These sample and hold modes correspond to the first and second phases, respectively, of the voltage detecting device of FIG. 1. The sample-and-hold circuit may be replaced by a track-and-hold circuit.

In the sample mode, the sample-and-hold circuit 102 samples input signals on the sampling capacitors CS1 and CS2. In the hold mode, the sample-and-hold circuit holds the signals sampled on the sampling capacitors in the preceding sample mode and outputs them from the operational amplifier Amp.

The operational amplifier Amp is a fully balanced operational amplifier having an inverting input terminal, a non-inverting input terminal, an inverting output terminal, and a non-inverting output terminal. The inverting input terminal and the non-inverting output terminal of the operational amplifier are coupled together through the sampling capacitor CS2 and the hold switch SHN (the hold mode) or disconnected from each other (the sample mode). The common-mode voltage of the operational amplifier is determined by the internal common-mode feedback circuit.

The sampling capacitors CS1 and CS2 sample signals input from a cell to be measured (the sample mode) or couple the inverting and non-inverting input terminals of the operational amplifier Amp to its non-inverting and inverting output terminals, respectively, while holding the sampled signals (the hold mode). More specifically, in the sample mode the sampling capacitors CS1 and CS2 have their one ends connected together through the sampling switches SSP and SSN. The sampling capacitor CS1 has its other end connected to the positive terminal of a cell Bi to be measured through the switch Si-1, while the sampling capacitor CS2 has its other end connected to the negative terminal of that cell Bi through the switch Si-3. The terminal provided between the sampling switches SSP and SSN is connected to the negative terminal of the cell Bi through the switch Si-2. That is, in the sample mode, the sampling capacitors CS1 and CS2 are charged by the cell Bi so that the voltage across the capacitor CS1 becomes VB and the voltage across the capacitor CS2 becomes zero.

The sampling switches SSP and SSN are controlled by the controller 105 so that they are turned on in the sample mode and off in the hold mode. The hold switches SHP and SHN are controlled by the controller 105 so that they are turned on in the hold mode and off in the sample mode.

The ADC 104 converts a signal output from the operational amplifier Amp in the sample-and-hold circuit 102 into a digital value, which is in turn fed to the controller 105 as the measurement of the cell voltage. The system of the ADC 104 is not limited and may be of a flash type, a pipeline type, a delta sigma type, or any other type.

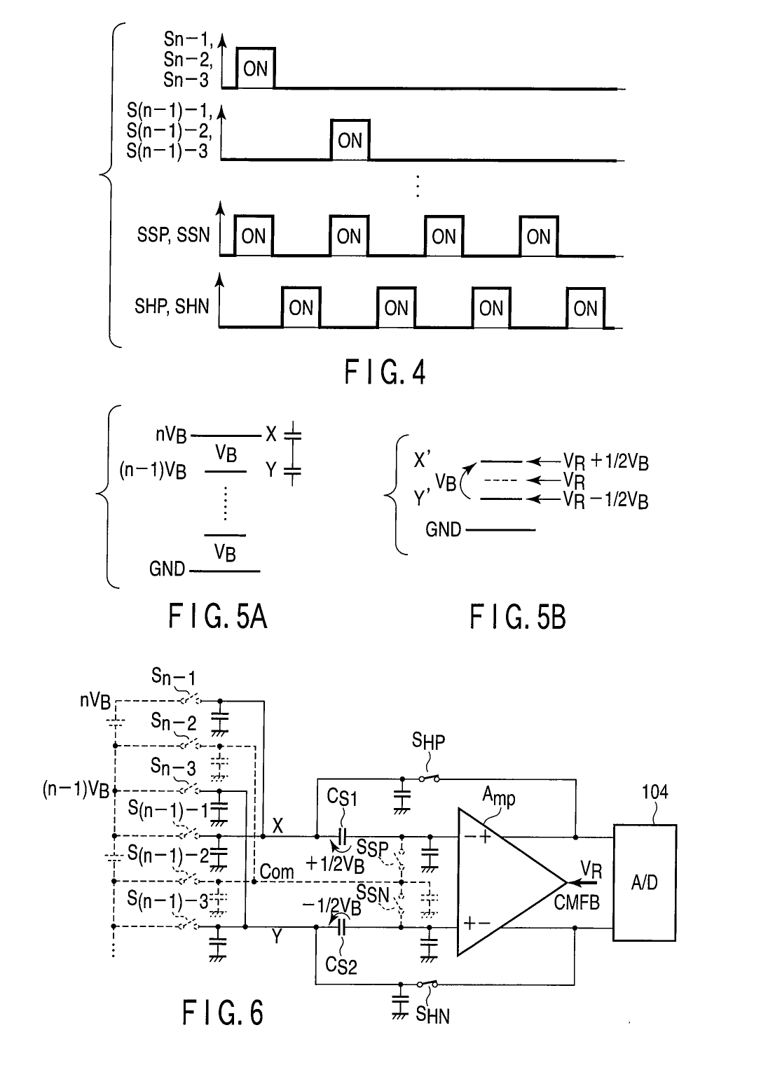

The controller 105 mainly controls the first and second switch groups 101 and 103. Specifically, the controller switches cells to be measured through on-off control of the first switch group 101 as shown in FIG. 4. The on-off control of the first switch group 101 by the controller 105 may be implemented so as to switch cells to another in an arbitrary fashion. Alternatively, the on-off control may be implemented so as to follow specific rules. From the point of view of detecting the voltages of the individual cells, it is desirable that the switching of cells be made on all the cells rather than on specific cells. The controller switches between the first and second phases of the voltage detecting device of FIG. 1 by alternately turning on the sampling switches SSP and SSN and the hold switches SHP and SHN in the second switch group 103 as shown in FIG. 4.

In addition, the controller 105 stores the measurements of the cell voltages input from the ADC 104 to the memory 106 and sends the measurements read from the memory to the communication unit 107.

The memory 106 receives the measurements of the voltages of the cells B1 to Bn from the controller 105 and stores them. The memory may be stored with additional information, such as times at which the measurements were made, in association with the measurements of the cell voltages. The voltage measurements stored in the memory are read by the controller 105 when necessary. The communication unit 107 makes communication with other equipment. Specifically, the communication unit sends or receives data to or from the other protection units or the management unit 6.

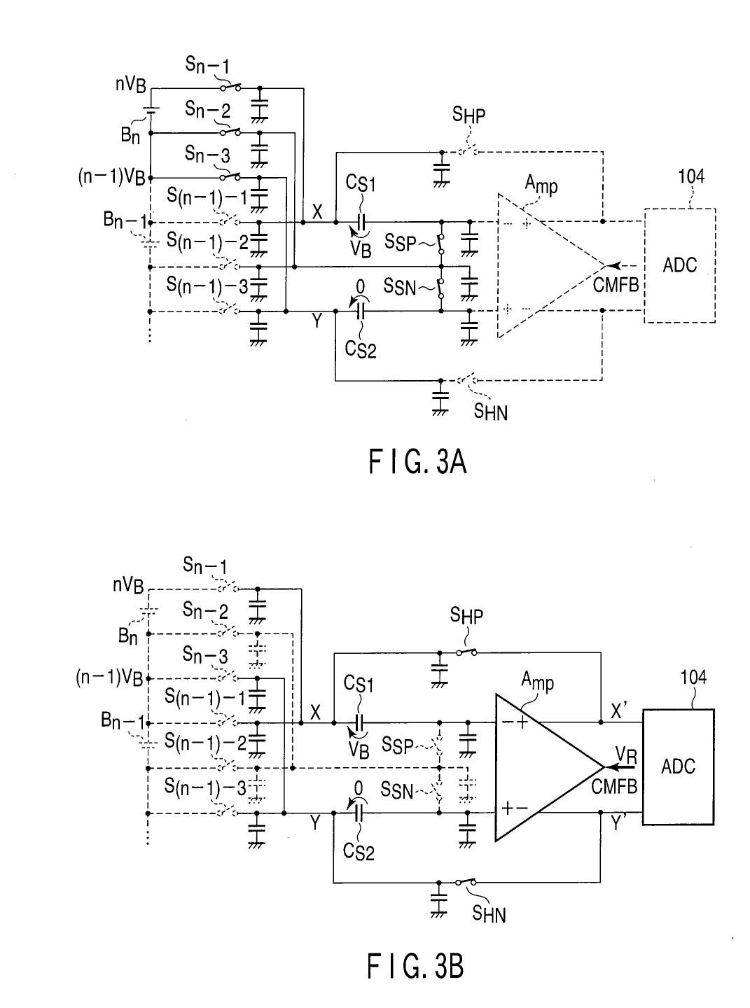

The operation of the voltage measuring device of FIG. 1 in the first and second phases will be described below with reference to FIGS. 3A and 3B, in which the battery to be measured is supposed to be Bn.

As shown in FIG. 3A, in the first phase the controller 105 turns on the switches Sn-1, Sn-2 and Sn-3 corresponding to the cell Bn to be measured and turns off the switches corresponding to the other cells. Moreover, the controller turns on the sampling switches SSP and SSN and turns off the hold switches SHP and SHN.

One end of the sampling capacitor CS1 is supplied with a voltage of (n-1)VB because it is connected to the negative terminal of the cell Bn to be measured through the sampling switch SSP and the switch Sn-2. The other end (node X) of the sampling capacitor CS1, being connected to the positive terminal of the cell Bn through the switch Sn-1, is supplied with a voltage of nVB. That is, the sampling capacitor CS1 is charged so that the voltage across it matches VB.

One end of the sampling capacitor CS2, being connected to the negative terminal of the cell Bn to be measured through the sampling switch SSN and the switch Sn-2, is supplied with a voltage of (n-1)VB. The other end (node Y) of the sampling capacitor CS2, being connected to the negative terminal of the cell Bn through the switch Sn-1, is supplied with a voltage of (n-1)VB. That is, the voltage across the sampling capacitor CS2 becomes zero volts.

As described above, the differential voltage between the nodes X and Y nearly matches VB at the termination of the first phase as shown in FIG. 5A. The parasitic capacitors associated with the switches shown in FIG. 3A are also charged by the cell Bn to be measured.

As shown in FIG. 3B, the controller 105 turns the hold switches SHP and SHN on and all other switches off at the start of the second phase. The other end (node X) of the sampling capacitor CS1 is connected to the non-inverting output terminal (node X′) of the operational amplifier Amp through the hold switch SHP. The other end (node Y) of the sampling capacitor CS2 is connected to the inverting output terminal (node Y′) of the operational amplifier Amp through the hold switch SHN. Since the sampling switches SSP and SSN are turned off, the sampling capacitors CS1 and CS2 are disconnected from each other and as a result no transfer of charges occurs. Therefore, the differential voltage VB between the nodes X and Y is nearly held as the differential voltage between the nodes X′ and Y′. Since the common-mode voltage VR is set by the common-mode feedback circuit within the operational amplifier Amp, the amplifier outputs to the ADC 104 a voltage of VR±VB/2 which is centered at VR as shown in FIG. 5B. In FIG. 3B, the parasitic capacitors of the switches are driven by the operational amplifier Amp and hence the problem of redistribution of charges to the sampling capacitors CS1 and CS2 will not arise unlike the flying capacitor circuit. The parasitic capacitors associated with the sampling switches SSP and SSN are not objects to be driven by the operational amplifier. However, these parasitic capacitors cause no problem because the differential voltage between the inverting and non-inverting input terminals of the operational amplifier becomes substantially zero volts provided that its gain is sufficiently large.

As described above, the assembled-battery voltage measuring device of this embodiment uses a sample-and-hold circuit and, in measuring the voltages of cells, drives parasitic capacitors by the operational amplifier in the sample-and-hold circuit. According to the voltage measuring device of this embodiment, therefore, it becomes possible to suppress the measurement errors attributed to parasitic capacitors.

### Second Embodiment

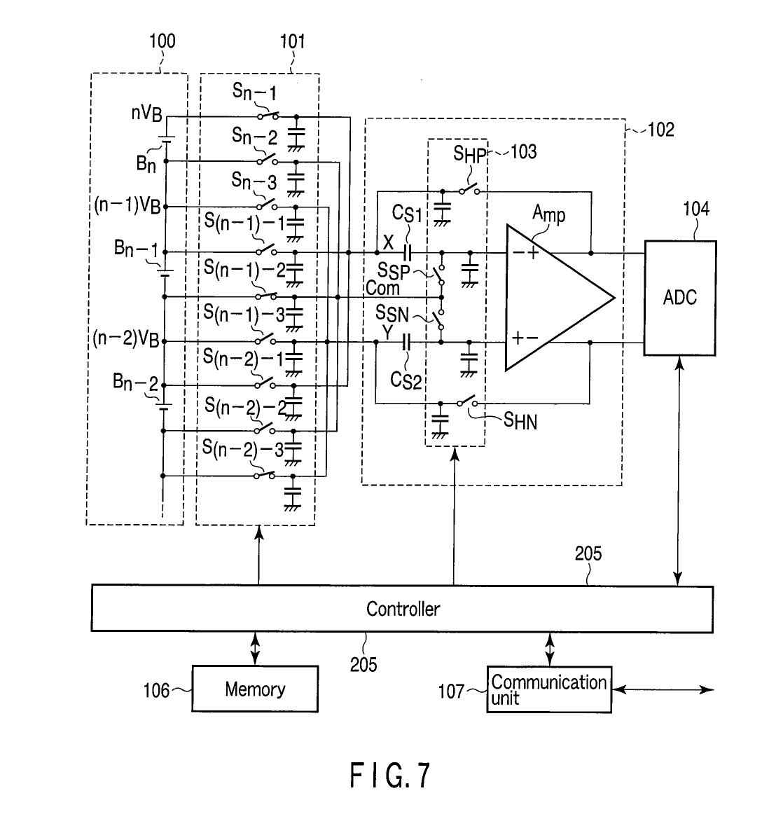

As shown in FIG. 7, an assembled-battery voltage measuring device according to a second embodiment of the present invention is configured such that the controller 105 in the voltage measuring device of FIG. 1 is replaced with a controller 205. In the description which follows, corresponding parts in FIG. 7 to those in FIG. 1 are denoted by like reference characters to thereby simplify the description.

The controller 205 is adapted to select, as a candidate for measurement, a pair of cells which are adjacent to each other rather than each individual cell. For example, in selecting a pair of cells Bn and Bn-1, in the first phase the controller 205 turns on the switch Sn-1 connected to the positive terminal of the cell Bn, the switch S(n-1)-2 connected to the common terminal of the cells Bn and Bn-1, and the switch S(n-2)-3 connected to the negative terminal of the cell Bn-1.

That is, in the first phase, the controller 205 connects the positive terminal of the cell on the high-voltage side of the paired cells to be measured (referred to as the first cell for convenience) to one end (node X) of the sampling capacitor CS1 in the sample-and-hold circuit 102. In addition, the controller 205 connects the negative terminal of the cell on the low-voltage side of the paired cells to be measured (referred to as the second cell for convenience) to one end (node Y) of the sampling capacitor CS2 in the sample-and-hold circuit 102. Moreover, the controller connects the common terminal of the first and second cells to the terminal (node Com) set between the sampling switches SSP and SSN in the sample-and-hold circuit 102. In the first phase, therefore, the sampling capacitors CS1 and CS2 are charged by the paired cells to be measured so that the voltage across each of them becomes VB.

The technical significance of setting a pair of cells rather than each individual cell as a candidate for measurement will be explained below.

With the voltage measuring device of FIG. 1, immediately after the start of the second phase, charges corresponding to the voltage VB have been stored on the sampling capacitor CS1 as shown in FIG. 3B. However, in the second phase, common-mode currents flow through the sampling capacitors CS1 and CS2 through the common-mode feedback in the operational amplifier Amp and hence the state gradually approaches that shown in FIG. 6. That is, at the termination of the second phase, the voltage across each of the sampling capacitors CS1 and CS2 becomes VB/2.

When the transition is continuously made from the state of FIG. 6 to the first phase, the cell to be measured will charge the sampling capacitor CS1 until the voltage across it becomes VB again. This charging process extracts charges from the cell to be measured, which may reduce its remaining power.

With the voltage measuring device of FIG. 7, on the other hand, the voltage across each of the sampling capacitors CS1 and CS2 remains at nearly VB at the start and termination of the second phase. In continuously changing to the first phase, there is no need to extract charges from the paired cells (there is no need of charging).

As described above, the assembled-battery voltage measuring device of the second embodiment sets a pair of cells which are adjacent to each other as a candidate for measurement. According to the voltage measuring device of this embodiment, therefore, there is no need to extract charges from paired cells to be measured in continuously making voltage measurements, thus allowing the reduction of remaining power of the paired cells to be prevented.

### Third Embodiment

The assembled-battery voltage measuring device of the second embodiment sets a pair of cells which are adjacent to each other as a candidate for measurement and cannot therefore detect the voltage across each individual cell. The third embodiment of the present invention uses the assembled-battery voltage measuring devices of the first and second embodiments in combination. In the voltage measuring device of the third embodiment, the controller 105 of FIG. 1 or the controller 205 of FIG. 7 is replaced with a controller 305. The other configuration remains unchanged.

That is, the assembled-battery voltage detecting device of this embodiment makes voltage measurement with each pair of cells as a candidate for measurement in the same manner as the second embodiment and voltage measurement with one arbitrary cell as a candidate for measurement in the same manner as the first embodiment. If all pairs of cells have been subjected to voltage measurement, from the measurement of the voltage across one cell the voltages of all other cells can be calculated one after another.

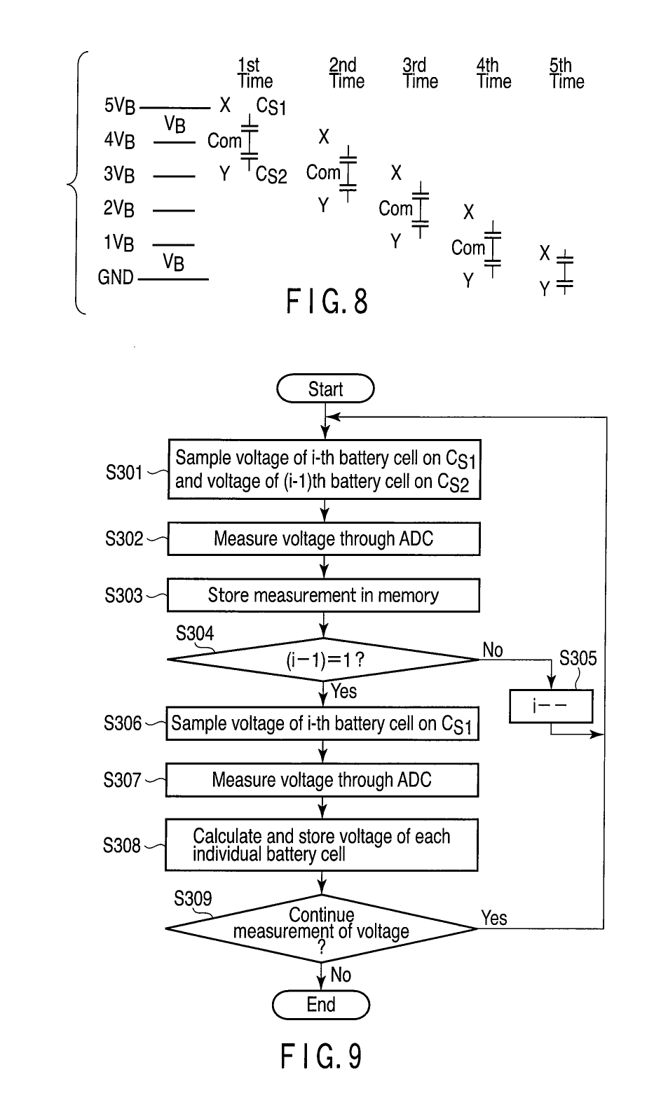

Suppose, for example, that, as shown in FIG. 8, the fifth and fourth cells are measured for the first time, the fourth and third cells for the second time, the third and second cells for the third time, the second and first cells for the fourth time, and the first cell for the fifth time. Subtracting the voltage measurement of the first battery from the voltage measurement of the second and first cells leads to the voltage of the second cell. In this way, the voltages of all other cells can be calculated one after another.

The operation of the assembled-battery voltage measuring device of the third embodiment will be described below with reference to FIG. 9.

First, the controller 305 selects the i-th cell Bi and the (i-1)th cell Bi-1 as paired cells to be measured and the sample-and-hold circuit 102 samples the differential voltage on the sampling capacitors CS1 and CS2 (step S301). The initial value of i is the number, n, of the cells which are connected in series.

Next, the ADC 104 converts an output signal of the operational amplifier Amp in the sample-and-hold circuit 102 into a digital signal to provide the measurement of the voltage of the paired cells (step S302). The controller 305 stores the voltage measurement obtained in step S302 in the memory 106 (step S303).

A decision is then made as to whether or not (i−1) is 1 (in step S304). If i−1=1, then the procedure goes to step S306; otherwise, i is decremented by one in step S305 and the procedure then returns to step S301.

In step S306, the controller 305 selects the j-th cell Bj (j is a natural number of n or less) as a candidate for measurement, and the sample-and-hold circuit 102 samples the differential voltage on the sampling capacitor CS1.

Next, the ADC 104 converts a signal output from the operational amplifier Amp in the sample-and-hold circuit 102 into a digital signal to provide the measurement of the voltage across the cell Bj (step S307). Based on the measurement obtained in step S307, the controller 305 calculates the voltage of each individual cell in sequence and then stores them in the memory 106 (step S308). If the voltage measurement is continued, i and j are set properly and the procedure then goes to step S301; otherwise, the procedure is complete.

Although, in the above example, voltage measurement is made on all the pairs of cells by decrementing i one by one with its initial value set at n, the order of voltage measurement is not limited. For example, i may be incremented one by one with its initial value set to 2 or may be incremented or decremented one by one with its initial value set to a natural number of 2 to n.

In particular, when the voltage measurement processing is performed continuously, it is desirable to set the initial value of i to the value corresponding to a pair of cells for which the highest voltage measurement was obtained at the last measurement (measurement cycle). As described above, when voltage measurement is made on one cell, charges are drawn from a pair of cells at the next voltage measurement. Therefore, variations in voltage among cells can be expected to be reduced by allocating a pair of cells for which the highest voltage measurement was obtained. The higher the voltage to ground of a cell is, the more it is affected by parasitic capacitance and the more its voltage tends to drop. Accordingly, it is desirable that j be set close to 1 at the first measurement time.

As described above, the assembled-battery voltage measuring device of the third embodiment uses the first and second embodiments in combination. Therefore, the voltage measuring device of this embodiment allows the measurements of the voltages of individual cells to be obtained while suppressing the extraction of charges to a minimum.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

As an example, although the first, second and third embodiments have been described using MOS transistors as switches, other transistors, such as bipolar transistors, may be used as switches.

What is claimed is:

1. A voltage measuring device for use with an assembled battery including a plurality of series-connected cells, comprising:
a sample-and-hold circuit including a first capacitor, a second capacitor and an operational amplifier, a sample-and-hold circuit being alternated between (a) a sample mode in which a signal input from a cell to be measured of the plurality of cells is sampled so that a voltage across the first capacitor becomes equal to a voltage across the cell to be measured, and a voltage across the second capacitor having its one end connected to one end of the first capacitor becomes equal to zero volts and (b) a hold mode in which the connection between the first capacitor and second capacitor is opened, the first capacitor establishes a connection between an inverting input terminal and a non-inverting output terminal of the operational amplifier, and the second capacitor establishes a connection between a non-inverting input terminal and an inverting output terminal of the operational amplifier; and
an analog-to-digital converter which converts a signal output from the operational amplifier into a digital signal.

2. The device according to claim 1, wherein, in the sample mode, the first capacitor has its other end connected to a positive terminal of the cell to be measured, the second capacitor has its other end connected to a negative terminal of the cell to be measured, and each of the first capacitor and second capacitor has its one end connected to one of the positive terminal and negative terminal of the cell to be measured.

3. The device according to claim 1, further comprising:
switches including one end connected to the first capacitor or the second capacitor and another end connected to each of the cells, to select the cell to be measured; and
a controller to turn on or off the switches.

4. The device according to claim 3, wherein the switches are MOS switches.

5. The device according to claim 3, wherein the controller sequentially changes over the switches so that the cells are selected one after the other as a candidate for measurement.

6. A voltage measuring device for use in an assembled battery including a plurality of series-connected cells, comprising:
a sample-and-hold circuit including a first capacitor, a second capacitor and an operational amplifier,
a sample-and-hold circuit being alternated between (a) a sample mode in which a signal input from a pair of first and second adjacent cells, as a candidate for measurement, of the plurality of cells is sampled so that a voltage across the first capacitor becomes equal to a voltage across the first cell, and a voltage across the second capacitor having its one end connected to one end of the first capacitor becomes equal to a voltage across the second cell and (b) a hold mode in which the connection between the first capacitor and second capacitor is opened, the first capacitor establishes a connection between an inverting input terminal and a non-inverting output terminal the an operational amplifier, and the second capacitor establishes a connection between a non-inverting input terminal and an inverting output terminal of the operational amplifier; and
an analog-to-digital converter which converts a signal output from the operational amplifier into a digital signal.

7. The device according to claim 6, wherein, in the sample mode, the first capacitor has its other end connected to a positive terminal of the first cell, the second capacitor has its other end connected to a negative terminal of the second cell, and each of the first capacitor and second capacitor has its one end connected to a common terminal of the first cell and second cell.

8. The device according to claim 6, further comprising:
switches including one end connected to the first capacitor or the second capacitor and another end connected to each of the cells, to select the pair of cells as a candidate for measurement; and
a controller to turn on or off the switches.

9. The device according to claim 8, wherein the switches are MOS switches.

10. The device according to claim 8, wherein the controller sequentially changes over the switches so that pairs of cells are selected from the cells one after the other as a candidate for measurement.

11. A voltage measuring device for use in an assembled battery including a plurality of series-connected cells, comprising:
a sample-and-hold circuit including a first capacitor, a second capacitor and an operational amplifier,
a sample-and-hold circuit being adapted to be switched between first operation mode and second operation mode, the first operation modes alternating between (a) a first sample mode in which a signal input from a pair of first and second adjacent cells, as a candidate for measurement, of the plurality of cells is sampled so that a voltage across the first capacitor becomes equal to a voltage across the first cell, and a voltage across the second capacitor having its one end connected to one end of the first capacitor becomes equal to a voltage across the second cell and (b) a first hold mode in which the connection between the first capacitor and second capacitor is opened, the first capacitor establishes a connection between an inverting input terminal and a non-inverting output terminal of the operational amplifier, and the second capacitor establishes a connection between a non-inverting input terminal and an inverting output terminal of the operational amplifier and the second operation mode alternating between (c) a second sample mode in which a signal input from a cell to be measured of the plurality of cells is sampled so that the voltage across the first capacitor becomes equal to a voltage across the cell to be measured, and the voltage across the second capacitor becomes equal to zero volts and (d) a second hold mode in which the connection between the first capacitor and second capacitor is opened, the first capacitor establishes the connection between the inverting input terminal and the non-inverting output terminal of the operational amplifier, and the second capacitor establishes the connection between the non-inverting input terminal and the inverting output terminal of the operational amplifier; and
an analog-to-digital converter which converts a signal output from the operational amplifier into a digital signal.

12. The device according to claim 11, wherein, in the first sample mode, the first capacitor has its other end connected to a positive terminal of the first cell, the second capacitor has its other end connected to a negative terminal of the second cell, and each of the first capacitor and second capacitor has its one end connected to a common terminal of the first cell and second cell and, in the second sample mode, the first capacitor has its other end connected to a positive terminal of the cell to be measured, the second capacitor has its other end connected to a negative terminal of the cell to be measured, and each of the first capacitor and second capacitor has its one end connected to one of the positive terminal and negative terminal of the cell to be measured.

13. The device according to claim 12, further comprising:
switches including one end connected to the first capacitor or the second capacitor and another end connected to each of the cells, to select the pair of cells as a candidate for measurement and the cell to be measured; and
a controller to turn on or off the switches.

14. The device according to claim 13, wherein the switches are MOS switches.

15. The device according to claim 13, wherein the controller sequentially changes over the switches so that pairs of cells are selected from the cells one after the other as a candidate for measurement and one of the cells is selected as the cell to be measured.

16. The device according to claim 15, wherein the controller sequentially calculates a voltage of each of the cells based on the measurement of the voltage of the cell to be measured and the measurements of the voltages of the pairs of cells.

17. The device according to claim 16, further comprising a storage unit to store the measurements of the voltages of the pairs of cells and the voltage of each of the cells, and wherein the controller first selects a pair of cells which indicates the highest voltage measurement among the voltage measurements for the pairs of cells stored in the storage unit as a candidate for measurement at following voltage measurement cycle.

18. An assembled battery system comprising:
an assembled battery including a plurality of cells which are connected in series; and
the device according to claim 1.
